(19) United States
(12) Patent Application Publication
(10) Pub. No.: US 2012/0053801 A1
(43) Pub. Date: Mar. 1, 2012

(54) METHOD AND APPARATUS FOR ESTIMATING CLUTCH FRICTION COEFFICIENT

(75) Inventor: Goetz Hangen, Wolfsheim (DE)

(73) Assignee: GM GLOBAL TECHNOLOGY OPERATIONS LLC, Detroit, MI (US)

(21) Appl. No.: 13/318,758

(22) PCT Filed: Mar. 10, 2010
(86) PCT No.: PCT/EP2010/001471

§ 371 Date: Nov. 3, 2011

(30) Foreign Application Priority Data
May 5, 2009 (GB) 0907702.5

(51) Int. Cl. F16D 43/04; G01M 13/02

(52) U.S. Cl. 701/67

(57) ABSTRACT

A method is provided for estimating a transmissibility of a clutch in a vehicle powertrain, which includes, but is not limited to cutting off fuel supply of an engine driving a first side of the clutch, setting a clutch pressure between first and second sides of the clutch to a positive value at which there is a non-zero difference between angular accelerations at the first and second sides of the clutch, and deriving the estimated transmissibility from a deviation between the angular acceleration difference and an angular acceleration caused by a drag torque of the engine.

### CROSS-REFERENCE TO RELATED APPLICATIONS

This application is a U.S. National-Stage entry under 35 U.S.C. §371 based on International Application No. PCT/EP2010/001471, filed Mar. 10, 2010, which was published under PCT Article 21(2) and which claims priority to British Application No. 0907702.5, filed May 5, 2009, which are all hereby incorporated in their entirety by reference.

### TECHNICAL FIELD

The technical field relates to a method for estimating a friction coefficient of a clutch in a vehicle power train, and to a vehicle power train in which the method is used.

### BACKGROUND

A precise knowledge of the friction coefficient of mating clutch surfaces is important for automatic control of a clutch in a power train, in order, e.g., to control the pressure applied to first and second sides of the clutch so that a predetermined desired torque can be transmitted, to predict a time needed for synchronizing the first and second sides of the clutch under a predetermined pressure, and to control a shifting process accordingly. The torque transmissibility of a clutch in a vehicle power train depends on various quantities, which may vary from one power train to the next due to manufacturing tolerances of the clutch and of peripheral components thereof such as an actuator for driving opening and closure of the clutch, temperature and wear of friction surfaces of the clutch, etc. In particular the temperature can have a substantial influence on the friction between mating surfaces of the clutch, and is likely to vary considerably in short time intervals due to Joule heat generated at these surfaces. Also the mechanical characteristics of an actuator for operating the clutch and the nature of its control parameter can have an influence on the torque transmissibility. For example, if the control parameter is a position of the actuator, the rigidity of components connecting the actuator to the clutch have an influence on the clutch pressure corresponding to a given actuator position.

Many conventional engine controllers use software-based engine models that allow a calculation of the engine output torque based on a set of engine control variables such as engine speed, fuel injection amount, etc. In principle, based on calculated engine output torque, transmissibility of the clutch might be estimated: if the clutch is in a slipping state, the torque which is not transmitted by the clutch (i.e. the torque which exceeds the transmissibility of the clutch) will cause the engine speed to increase. Based on a known moment of inertia of the engine and a detected rotation acceleration of the engine, the non-transmitted torque can be calculated. Since the total torque is given by the engine model, the transmitted torque is then easily calculated. However, this approach has drawback in that any errors and inaccuracies of the engine model will affect the transmissibility estimate. Since the transmitted torque is a difference between the total torque obtained from the engine model and the torque associated to the rotation acceleration of the engine, the error of the transmissibility estimate may be considerable, and it is not straight-forwardly possible to specify an upper limit for this error.

Therefore, at least one object is therefore to provide a method for estimating a transmissibility of a clutch in a vehicle power train which is simple and reliable. In addition, other objects, desirable features and characteristics will become apparent from the subsequent summary and detailed description, and the appended claims, taken in conjunction with the accompanying drawings and this background.

### SUMMARY

A method is provided that comprise the steps of cutting off fuel supply of an engine driving first side of the clutch, setting a clutch pressure between first and second sides of the clutch to a positive value at which there is a non-zero difference between angular accelerations at the first and second sides of the clutch, and deriving an estimated transmissibility of the clutch from a deviation between said angular acceleration difference and an angular acceleration caused by a drag torque of the engine. By cutting off the fuel supply of the engine, almost all inaccuracies related to the use of a general engine model are avoided. The drag moment, i.e., the torque which would have to be applied at an output shaft of the engine for keeping its rotation speed constant, does evidently not depend on fuel supply characteristics, but only on internal friction of the engine, which, in turn depends practically exclusively on engine temperature. The engine temperature, however, is readily available, since practically any engine of a motor vehicle is equipped with a cooling water temperature sensor.

The requirement that the fuel supply of the engine shall be cut off does not impose a limitation for practical applicability of the method, since application of the method can easily be restricted to times when the fuel supply of the engine is cut off for other reasons. For example, the method may be carried out when the vehicle is coasting.

When coasting, the clutch will usually be closed, so that the engine is kept going by kinetic energy of the moving vehicle. As long as the clutch is closed, the angular acceleration difference between first and second sides of the clutch is zero. According to a first preferred embodiment, the clutch pressure of the coasting vehicle is gradually reduced to a value at which said angular acceleration difference is just beginning to become different from zero, i.e., it can be regarded as negligibly small but non-zero, corresponding to a state in which the two sides of the clutch are just beginning to slip. The estimated transmissibility may then be derived in deriving the estimated transmissibility of the clutch assuming the angular acceleration difference to be zero.

According to the above-defined first embodiment, the relation between clutch pressure and torque transmissibility is probed at a single specific pressure value only, namely at the slipping limit. Since other pressure values are practically relevant, too, it is practical to probe the characteristic at different pressures. This can be done by gradually increasing the clutch pressure in setting the clutch pressure. Preferably, the increase is from zero to a pressure at which the difference between the angular accelerations at the first and second sides of the clutch becomes zero.

An appropriate occasion where such a gradual increase may be carried out without affecting the operation of the vehicle is an upshifting process of the gearbox. In spite of the varying clutch pressure, the deviation may be processed quite straight forwardly in deriving the estimated transmissibility of the clutch by calculating an expected rotation speed of the first clutch side based on an earlier estimated value of the transmissibility and the engine drag torque, and obtaining an updated value of the transmissibility as a function of said expected rotation speed and an actual rotation speed of the first clutch side.

A method for shifting gears in a vehicle power train comprising at least an engine, a gearbox, a clutch for selectively coupling said gearbox to said engine, and an actuator for operating a clutch may make use of the above described transmissibility estimating method by controlling the pressure applied to a clutch during a synchronization of its first and second sides depending on a friction coefficient of the clutch estimated as explained above. In particular, in such a shifting method, the pressure applied to the clutch may be increased if a decrease of the transmissibility is detected, and/or the pressure applied to the clutch may be decreased if an increase of the transmissibility is detected, in order to keep the synchronization time substantially independent of the transmissibility.

Similarly, the duration of the shifting process may be increased if a decrease of transmissibility is detected, and/or the duration may be decreased if an increase of the transmissibility is detected, in order to take account of synchronization times becoming longer or shorter depending on the transmissibility.

A vehicle power train is also provided that comprises at least an engine, a gearbox, a clutch for selectively coupling the gearbox to the engine, an actuator for operating a clutch, a controller for outputting a control parameter to the actuator and sensor means for detecting a difference between angular accelerations at first and second sides of the clutch. The controller is adapted to derive an estimated transmissibility of the clutch from a deviation between said detected angular acceleration difference and an angular acceleration caused by a drag torque of the engine.

### BRIEF DESCRIPTION OF THE DRAWINGS

The present invention will hereinafter be described in conjunction with the following drawing figures, wherein like numerals denote like elements, and:

FIG. 1 is a block diagram of a vehicle power train; and

FIG. 2 is a flow chart of a method carried out by the controller of FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

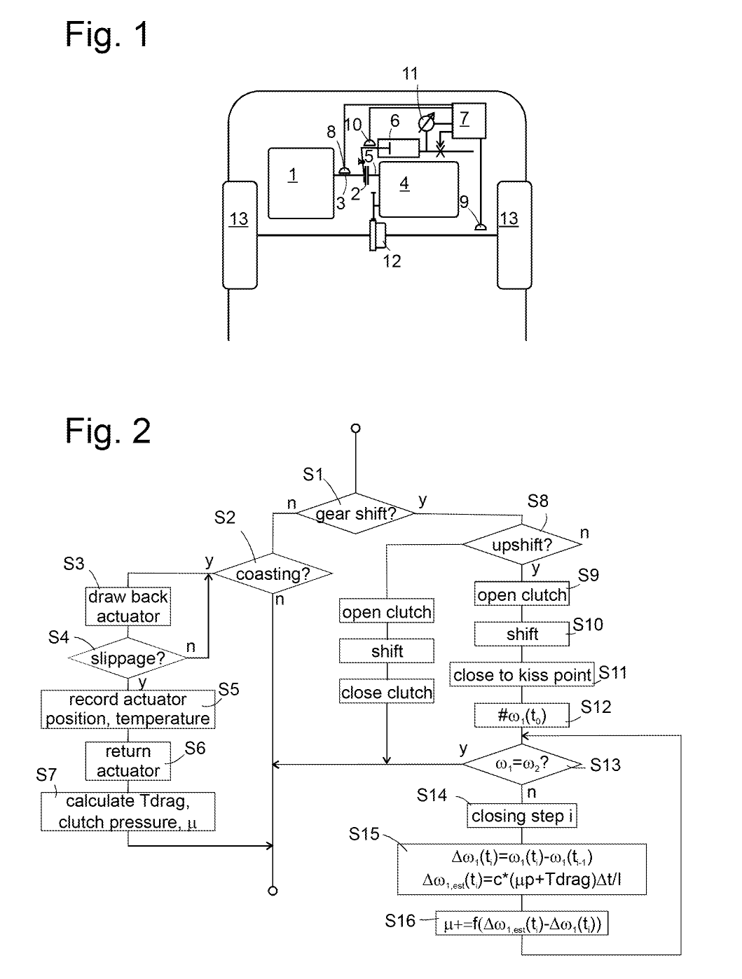

FIG. 1 is a schematic plan view of a front portion of a motor vehicle comprising a combustion engine 1, a clutch 2 for connecting an output shaft 3 of the combustion engine to an input shaft 5 of a gearbox 4, an actuator 6, e.g., a hydraulic cylinder, for controlling opening and closure of clutch 2, an electronic transmission controller 7 for controlling clutch 2 by means of actuator 6 and controlling shift forks, not shown, of gearbox 4 by means of other actuators, not shown either.

The controller 7 has connected to it a rotation speed sensor 8 for monitoring the rotation speed of output shaft 3, a speedometer 9 and an actuator controller sensor, e.g. a Hall sensor 10 for monitoring displacement of a piston of actuator 6, or a pressure sensor 11 for monitoring the hydraulic pressure inside a cylinder of actuator 6. Reference numeral 12 denotes a differential driven by an output pinion of gearbox 4, and 13 denotes driven vehicle wheels.

The transmission controller 7 monitors operating parameters such as engine rotation speed, vehicle speed, vehicle load, etc., and based on these operating parameters it selects an appropriate gear in gearbox 4 in a conventional manner which need not be described in further detail. For an understanding it should be keep in mind that the transmission controller 7 continuously decides whether a gear shift should be carried out or not (see step S1 in FIG. 2). If it decides that no gear shift is carried out, the transmission controller proceeds to step S2 in which it decides whether the vehicle is in a coasting mode or not. It will decide that the vehicle is in a coasting mode if it is informed by an engine controller, not shown, that fuel supply to engine 1 is cut off, and if, at the same time, clutch 2 is in a closed state, with a high pressure between its mating surfaces.

If the vehicle is found to be in the coasting state, the transmission controller 7 causes actuator 6 to withdraw, thus reducing the pressure in clutch 2, until slippage between input and output sides of the clutch is detected in step S4. Slippage may be detected e.g., based on a discrepancy between the vehicle speed as detected by speedometer 9 and an expected vehicle speed calculated based on engine rotation speed and the transmission ratio of gearbox 4. If slippage is detected, the transmission controller 7 immediately stops the actuator 6, and records actuator position and engine temperature in step S5. Optionally, before recording actuator position and temperature the actuator 6 may be advanced again, at a reduced speed, until slippage ceases to be detected. It is not crucial whether at the recorded position slippage is exactly zero or whether it is slightly different from zero; but the recorded position should be as close to the slipping limit as the precision of slippage detection allows.

When the actuator position has been recorded, the actuator returns to its initial position in step S6, since prolonged slippage would only cause undesirable heating and wear of the clutch.

From the engine temperature, an engine drag torque Tdrag is obtained using e.g. a look-up table. The drag torque data recorded in the look-up table may be obtained by the engine manufacturer for that same engine 1 or for an engine of identical design; preferably they are repeatedly updated automatically by the transmission controller 7 during the lifetime of the engine 1 in order to take account of engine aging, variations of lubricant quality, etc.

Similarly, a clutch pressure associated to the recorded actuator position may be determined from a look-up table. A coefficient μ which is representative of friction between mating surfaces of the clutch, i.e., of the transmissibility of the clutch 2, is obtained by dividing the drag torque Tdrag by the clutch pressure.

If a gear shift is found to be appropriate in step S1, step S8 decides whether an upshift or a downshift will take place. In case of an upshift, the fuel supply to the engine 1 is cut off, and the transmission controller 7 opens the clutch (S9) and carries out the appropriate shifting operation in gearbox 4 (S10). The clutch is then gradually closed again; at an instant t₀ when it reaches the so called kiss point, i.e., when mating surfaces come into contact (S11), the rotation speed ω₁(t₀) of output shaft 3 is detected in step S12.

Step S13 verifies whether the rotation speed ω₁ of output shaft 3 is identical to the rotation speed ω₂ of input shaft 5. Since the surfaces have just made contact, and the transmissibility of the clutch is substantially zero, the rotation speeds are not identical, so that the clutch is closed somewhat further in step S14. Subsequently, at a time tᵢ=tᵢ₋₁+Δt, i being a positive integer and Δt being a constant time interval at which steps S13-S16 are iterated, the current rotation speed ω₁(tᵢ) of output shaft 3 is measured, and a difference Δω₁(tᵢ)=ω₁(tᵢ)−ω₁(tᵢ₋₁) between the current rotation speed ω₁(tᵢ) and the rotation speed ω₁(tᵢ₋₁)measured in step S12 or in a previous iteration of step S15 is obtained.

An expected change Δ ω_{1,est}(tᵢ) of the rotation speed between times tᵢ and tᵢ₋₁ is calculated. Two effects contribute to this change, namely the drag torque and the torque transmitted by the clutch. Therefore the expected change Δ ω_{1,est} is calculated as c(μp+Tdrag)Δt/I, where μ is a current estimate of the friction coefficient, p is the clutch pressure, which is either directly read from pressure sensor 11, if present, or is derived from position data provided by Hall sensor 10, assuming that the pressure p is a known function of the actuator position, I is the moment of inertia of the engine 1, and c is a suitably determined empirical constant. Initially, the estimated friction coefficient μ can be a predetermined constant, or, if available, it can be the friction coefficient μ obtained in step S7.

If the estimated friction coefficient μ is correct, there should be no discrepancy between Δω_{1,est} and Δω₁. If there is a discrepancy, it is indicative of an error of μ, so that in step S16, μ is updated by adding a correction term which is a predetermined function f(ε) of the estimation error ε=Δω_{1,est}(tᵢ)−Δω₁(tᵢ). The function f can be an offset-free linear function, i.e. a function of the type f(ε)=c ε, with c being a constant, or it can be zero in a small interval around ε=0, and have constant values of equal amount and opposite sign for ε above or below said interval. With the correction function f(ε) appropriately chosen, the estimated friction coefficient μ converges towards the true value after a number of iterations of steps S13 to S16.

1. A method for determining an estimate transmissibility of a clutch in a vehicle powertrain, comprising:
cutting off fuel supply of an engine driving a first side of the clutch;
setting a clutch pressure between a first side and a second side of the clutch to a positive value at which there is a non-zero difference between an angular accelerations at the first side and the second side of the clutch; and
deriving said estimated transmissibility from a deviation between said non-zero acceleration difference and a second angular acceleration caused by a drag torque of the engine.

2. The method of claim 1, wherein the cutting, the setting, and the deriving are carried out while the vehicle is coasting.

3. The method of claim 2,
wherein in the setting, the clutch pressure is gradually reduced to a value at which said non-zero difference is negligibly small but non-zero, and
wherein the deriving, the estimated transmissibility is derived assuming the angular acceleration difference to be zero.

4. The method of claim 1, wherein in the setting, the clutch pressure is gradually increased.

5. The method of claim 4, wherein the clutch is gradually increased from substantially zero to a pressure at which the difference between angular accelerations at the first side and the second side of the clutch becomes substantially zero.

6. The method of claim 4,
wherein in the deriving, an expected rotation speed of the clutch side is calculated based on an earlier estimated value of the transmissibility and the engine drag moment, and
wherein an updated value of the transmissibility is obtained as a function of said expected rotation speed and an actual rotation speed of the clutch side.

7. The method of claim 4, wherein the clutch is placed between the engine and a gearbox of the powertrain and the gradual increase of the clutch pressure is carried out while upshifting the gearbox.

8. The method of claim 1, wherein the drag torque of the engine is assumed to be a predetermined function of the engine temperature.

9. An apparatus for shifting gears in a vehicle powertrain, comprising:
an engine;
a gearbox;
a clutch configured to selectively couple said gearbox to said engine; and
an actuator configured to operate the clutch in which a pressure applied to the clutch during a synchronization of as first side and a second side of the clutch is controlled depending on an estimated transmissibility of the clutch; and
a controller configured to determine the estimated transmissibility of the clutch, the controller configured to:
cut off fuel supply of the engine driving a first side of the clutch;
set a clutch pressure between a first side and a second side of the clutch to a positive value at which there is a non-zero difference between angular accelerations at the first side and the second side of the clutch; and
derive said estimated transmissibility from a deviation between said angular acceleration difference and an angular acceleration caused by a drag torque of the engine.

10. The apparatus of claim 9, wherein the pressure applied to the clutch is increased if a decrease of the transmissibility is detected, and/or the pressure applied to the clutch is decreased if an increase of the transmissibility is detected.

11. The method of claim 9, wherein a duration of the shifting process is increased if a decrease of the transmissibility is detected.

12. A vehicle powertrain, comprising:
an engine;
a gearbox;
a clutch configured to selectively couple said gearbox to said engine;
an actuator configured to operate the clutch;
a sensor configured to detect a difference between an angular acceleration at a first side and a second side of the clutch; and
a controller configured to:
generate a control parameter to the actuator;
estimate an estimated transmissibility of the clutch from a deviation between said difference and an angular acceleration caused by a drag torque of the engine.

13. The vehicle powertrain of claim 12, wherein the controller is further configured to vary control parameters output to the actuator from one gear shifting process to another depending on the estimated transmissibility.

14. The apparatus of claim 9, wherein the pressure applied to the clutch is increased if the pressure applied to the clutch is decreased if an increase of the transmissibility is detected.
